(19) United States
(12) Patent Application Publication
(10) Pub. No.: US 2023/0034706 A1
(43) Pub. Date: Feb. 2, 2023

(54) COFFEE MAKER

(71) Applicant: TIGER CORPORATION, Osaka (JP)

(72) Inventors: YOSHIHIRO OKADA, Osaka (JP); KUNIHIKO TERAMOTO, Osaka (JP); SHIORI YONEHARA, Osaka (JP); YUSUKE KUZUHARA, Osaka (JP)

(73) Assignee: TIGER CORPORATION, Osaka (JP)

(21) Appl. No.: 17/866,531

(22) Filed: Jul. 17, 2022

(30) Foreign Application Priority Data
Jul. 29, 2021 (JP) 2021-124778

(51) Int. Cl. A47J 31/043; A47J 31/06

(52) U.S. Cl. CPC A47J 31/043; A47J 31/0657

(57) ABSTRACT

[Solution] A coffee maker 1 includes: an extraction container (second container 42) extracting coffee liquid from hot water and coffee powder; a server container (first container 41) storing the coffee liquid; a communication part 43 communicating an inside of the container and an inside of the server container; and a filter 44, disposed inside the extraction container. The coffee powder is filtered out and removed by permeating the coffee liquid through the filter. The coffee maker is configured to filter the coffee liquid by using the filter 44 while moving the coffee liquid from the extraction container to the server container via the communication part 43. The server container stores water as basis of the hot water for extracting the coffee liquid.

### CROSS-REFERENCE TO RELATED APPLICATION

This application claims the priority benefit of Japan application serial no. 2021-124778 filed on Jul. 29, 2021. The entirety of the above-mentioned patent application is hereby incorporated by reference herein and made a part of this specification.

### BACKGROUND

### Technical Field

The invention relates to a technique of a coffee maker which automatically extracts coffee liquid by using coffee powder and hot water.

### Description of Related Art

Various techniques relating to a coffee maker automatically extracting coffee liquid by using coffee powder and hot water are known. Such coffee makers include a siphon type and a drip type, for example.

In addition, it is known that such coffee maker includes an extraction container which extracts coffee liquid, a server container which stores the coffee liquid, and a filter which filters out and removes the coffee powder by making the coffee liquid permeate through the filter (see Patent Document 1). The coffee maker is configured so that after the coffee powder is soaked in hot water for a predetermined time in the extraction container, the coffee liquid is filtered out by the filter while being moved to the server container.

### Prior Art Documents

### Patent Documents

### [Patent Document 1] Japanese Laid-open No. 2017-55980

Here, in the coffee maker, it is necessary to provide a water tank which stores water as the basis of the hot water (hot water or steam) for extracting the coffee liquid in the extraction container, in addition to the extraction container and the server container. Therefore, in the coffee maker, it is necessary to provide a water tank in addition to the extraction container and the server container. Therefore, the number of parts increases, the size increases, and the maintainability is not favorable.

### SUMMARY

According to an embodiment of the invention, a coffee maker includes: an extraction container extracting coffee liquid from hot water and coffee powder; a server container storing the coffee liquid; a communication part communicating an inside of the extraction container and an inside of the server container; and a filter, disposed inside the extraction container. The coffee powder is filtered out and removed by permeating the coffee liquid through the filter. The coffee maker is configured to filter the coffee liquid by using the filter while moving the coffee liquid from the extraction container to the server container via the communication part. The server container stores water as basis of the hot water for extracting the coffee liquid.

### BRIEF DESCRIPTION OF THE DRAWINGS

FIG. 1 is a perspective view illustrating a coffee maker according to the invention.

FIG. 2 is a perspective view illustrating the same coffee maker.

FIG. 3 is a front view illustrating the same coffee maker.

FIG. 4 is a back view illustrating an internal structure of the same coffee maker.

FIG. 5 is a control block diagram illustrating the same coffee maker.

FIG. 6 is a control block diagram illustrating the same coffee maker.

FIG. 7 is an enlarged cross-sectional view of a first flow pipe of the same coffee maker.

FIG. 8 is an enlarged cross-sectional view of an extraction unit of the same coffee maker.

FIG. 9 is a partial exploded perspective view illustrating the extraction unit of the same coffee maker.

In FIG. 10, (A) is a schematic view illustrating a state in which hot water is poured into a second container, (B) is a schematic view illustrating a state in which coffee powder is soaked in hot water, and (C) is a schematic view illustrating a state in which coffee liquid permeates through a filter to extract the coffee liquid while flowing from a second container to a first container in the same coffee maker.

FIG. 11 is a control block diagram illustrating the same coffee maker.

FIG. 12 is a control block diagram illustrating the same coffee maker.

### DESCRIPTION OF THE EMBODIMENTS

The invention provides a coffee maker capable of reducing the number of parts, realizing compactness, and making the coffee maker more maintainable.

A coffee maker according to an aspect of the invention includes: an extraction container extracting coffee liquid from hot water and coffee powder; a server container storing the coffee liquid; a communication part communicating an inside of the extraction container and an inside of the server container; and a filter, disposed inside the extraction container. The coffee powder is filtered out and removed by permeating the coffee liquid through the filter. The coffee maker is configured to filter the coffee liquid by using the filter while moving the coffee liquid from the extraction container to the server container via the communication part. The server container stores water as basis of the hot water for extracting the coffee liquid.

According to the coffee maker according to the invention, it is configured to serve as a water tank as well as a server container. Therefore, the number of parts can be reduced, compactness can be realized, and the maintainability can be facilitated.

In the invention, the extraction container may be disposed below the server container.

According to the configuration, the operation of extracting the coffee liquid can be expressively carried out.

According to the invention, the communication part may include a contact part. The contact part may protrude toward a side of a lower part of the extraction container from an opening part at a lower end of the communication part, and contact an inner surface of the lower part of the extraction container inside the extraction container.

According to the configuration, it can prevent a small amount of the extracted coffee liquid in the extracted container from remaining in the extraction container without moving to the server container via the communication part.

In the invention, the coffee maker may include a subtank which temporarily stores a portion of the water stored in the server container.

According to the configuration, the situation in which the extraction of the coffee liquid cannot be not appropriately performed because the water (hot water, steam, etc.) other than the water (hot water) for soaking the coffee powder cannot be secured can be avoided.

According to the invention, after discharge of the coffee liquid completes, external gas may flow along a discharge path of the coffee liquid from the server container to a discharge port to discharge the coffee liquid remaining in the discharge path of the coffee liquid.

According to the configuration, after the discharge of the coffee liquid completes, the coffee liquid remaining in the discharge path of the coffee liquid can be prevented from dripping down (dropping) from the discharge port.

According to the invention, the coffee maker may be configured to generate a pressure difference between the inside of the extraction container and the inside of the server container and filter the coffee liquid by using the filter while moving the coffee liquid from the extraction container to the server container.

According to the configuration, the operation of extracting the coffee liquid can be expressively carried out.

### Overall Configuration of Coffee Maker

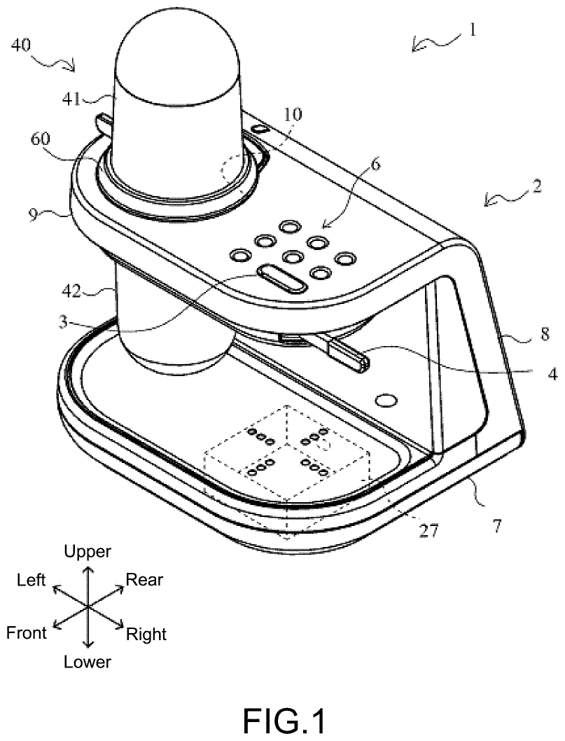

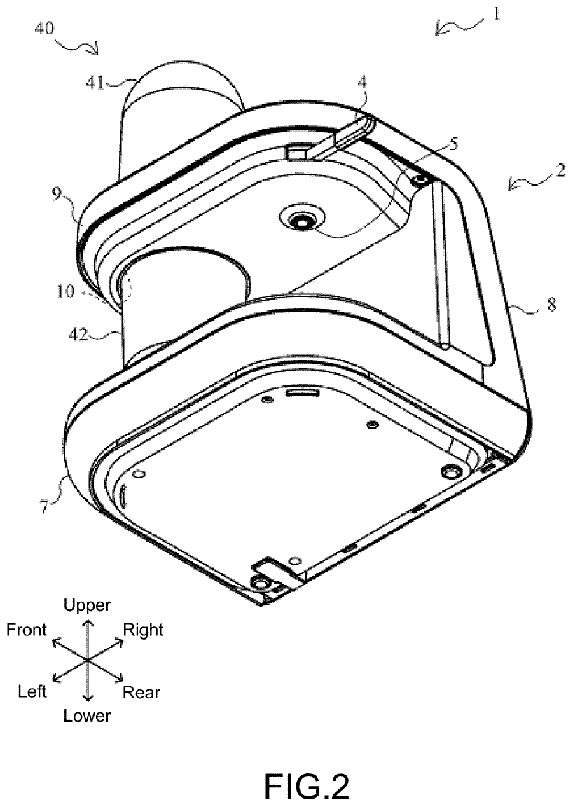

In the following, a coffee maker 1 shown in FIGS. 1 to 11 is described. The coffee maker 1 shown in FIGS. 1 to 11 is an embodiment of the coffee maker according to the invention. For the ease of description, a front-rear direction, a left-right direction, and an upper-lower direction are defined according to the arrows shown in FIGS. 1 to 4. However, the front-rear direction, the left-right direction, and the upper-lower direction shown in FIGS. 1 to 4 do not serve as limitations on the front-rear direction, the left-right direction, and the upper-lower direction of the coffee maker according to the invention. Moreover, the following expressions such as front, rear, left, right, upper, and lower in the following description indicate an orientation on the basis of a state in which the respective components forming the coffee maker 1 are assembled at predetermined positions when the coffee maker 1 is used.

With the user operating the coffee maker 1, the coffee maker 1 automatically extracts coffee liquid by using coffee powder and hot water. The coffee maker 1 is an immersion-type coffee maker 1, and extracts the coffee liquid by soaking the coffee powder in the hot water and then filtering the liquid by using a filter 44. As shown in FIGS. 1 to 3, the coffee maker 1 includes a main body 2 and an extraction unit 40.

### Main Body

As shown in FIGS. 1 to 3, the main body 2 includes an extraction switch 3, a discharge switch 4, a discharge port 5, and a flavor setting part 6, and supports the extraction unit 40. Various components for an operation in which the coffee maker 1 extracts coffee liquid are built in a housing of the main body 2. The main body 2 (housing) includes a lower part 7, a rear part 8, and an upper part 9, and is configured so that the rear part 8 extends upward from the rear end of the lower part 7, the upper part 9 extends forward from the upper end of the rear part 8, and is configured in a substantially C shape (“⊐” shape) from a side view. A support hole 10 penetrating through in the upper-lower direction is formed at the upper part 9 (the left part of the upper part 9) of the main body 2, and the main body 2 supports the extraction unit 40 in the support hole 10.

As shown in FIGS. 1 to 3, the extraction switch 3 is a push switch, and is disposed on the upper surface of the right part of the upper part 9. The extraction switch 3 is not limited to a push switch, and may also be configured as a touch panel, for example, and is set as appropriate in accordance with the specification or the purpose of the coffee maker 1. The discharge switch 4 is a lever switch, and is disposed on the side part of the right part of the upper part 9. The extraction switch 4 is not limited to a lever switch, and may also be configured as a touch panel, for example, and is set as appropriate in accordance with the specification or the purpose of the coffee maker 1. The discharge port 5 discharges the coffee liquid based on an instruction of the user. The discharge port 5 is provided on the lower surface of the right part of the upper part 9, and is open toward the lower side.

As shown in FIG. 1, the flavor setting part 6 is provided on the upper surface of the right part of the upper part 9. The flavor setting part 6 is operated by the user, performs various operations in the coffee maker 1, and performs various settings, etc., of the coffee maker 1. For example, with the user operating the flavor setting part 6, a selection on the flavor of the coffee liquid (e.g., selection between “refreshing” or “thick” or between “enhanced acidity” or “enhanced bitterness”) extracted by the coffee maker 1 is performed. The flavor setting part 6 is formed by multiple tact switches. It is noted that the flavor setting part 6 is not limited to such configuration, and may also be configured as a touch panel, for example, and is set as appropriate with regard of the configuration of a display aspect or a switch operation in accordance with the specification or the purpose of the coffee maker 1.

### Extraction Unit

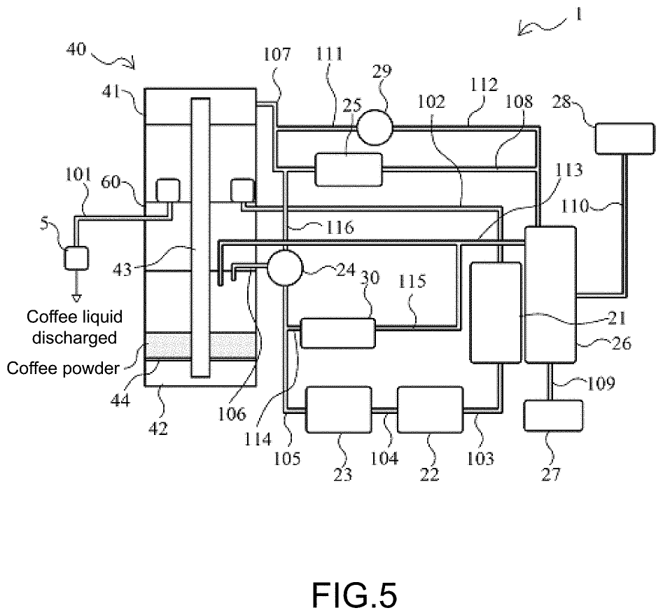

The extraction unit 40 extracts coffee liquid and stores the extracted coffee liquid. When the user operates the extraction switch 3, the coffee maker 1 automatically starts an extraction operation of the coffee liquid based on a program stored in a control part 11 in the extraction unit 40, and stores the extracted coffee liquid in the extraction unit 40. In addition, when the user operates the discharge switch 4, the coffee liquid stored in the extraction unit 40 is discharged from the discharge port 5. The extraction unit 40 is detachably supported by the main body 2. As shown in FIGS. 5, 7, and 9, the extraction unit 40 includes a first container 41, a second container 42, a communication part 43, the filter 44, a filter stand 47, and a support part 60.

The first container 41 stores water serving as the basis of the hot water (hot water or steam) for extracting the coffee liquid at a preceding stage of storing the coffee liquid. The storage of water into the first container 41 is performed by the user. In addition, the first container 41 stores the extracted coffee liquid. That is, the first container 41 is configured as serving as a water tank which stores water as well as a server container which stores coffee liquid. As shown in FIGS. 1 to 3, the first container 41 is disposed above (immediately above) the second container 42 and the support part 60. The first container 41 is a bottomed cylindrical member, and is configured by arranging a cylindrical part and a substantially hemispherical bottom part at the upper end of the cylindrical part. In a side view, the cylindrical part of the first container 41 is configured to have a slightly flared shape. In a state in which the extraction unit 40 is installed to the main body 2, the first container 41 is configured to protrude upward from the upper surface of the upper part 9 of the main body 2. The first container 41 is configured by using thermo-resistant glass. The first container 41 is configured to be transparent or semi-transparent, and is configured so that the stored water or coffee liquid is viewable from the outside. In addition, the shape of the first container 41 is not limited to such configuration, but can be in a shape as appropriate in accordance with the specification or the purpose of the coffee maker 1. In addition, the first container 41 is not limited to being formed by thermo-resistant glass, nor is it limited to being transparent or semi-transparent. The material, etc., forming the first container 41 is selected in accordance with the specification or the purpose of the coffee maker 1.

In the second container 42, the hot water and the coffee powder are mixed to soak the coffee powder in the hot water, and the coffee powder and the hot water are filtered by the filter 44 to extract the coffee water. That is, the second container 42 is configured as an extraction container extracting the coffee liquid from the coffee powder. As shown in FIGS. 1 to 3, the second container 42 is disposed below (immediately below) the first container 41 and the support part 60. The second container 42 is a bottomed cylindrical member, and is configured by arranging a cylindrical part and a substantially hemispherical bottom part at the lower end of the cylindrical part. In a side view, the cylindrical part of the second container 42 is configured to have a slightly reversed-flared shape. In a state in which the extraction unit 40 is installed to the main body 2, the second container 42 is configured to protrude downward from the lower surface of the upper part 9 of the main body 2. The second container 42 is configured by using thermo-resistant glass. The second container 42 is configured to be transparent or semi-transparent, and is configured so that the hot water or the extracted coffee liquid is viewable from the outside. In addition, the shape of the second container 42 is not limited to such configuration, but can be in a shape as appropriate in accordance with the specification or the purpose of the coffee maker 1. The second container 42 is not limited to being formed by thermo-resistant glass, nor is it limited to being transparent or semi-transparent. The material, etc., forming the second container 42 is selected in accordance with the specification or the purpose of the coffee maker 1.

Regarding the position relationship between the first container 41 and the second container 42, it is not limited that the first container 41 is disposed immediately above the second container 42. For example, it may also be configured that the first container 41 is arranged on a side of the second container 42, and, when viewed in a plan view or a side view, the first container 41 and the second container 42 are overlapped only in part. Alternatively, it may also be configured that, when viewed in a plan view or a side view, the first container 41 and the second container 42 are not overlapped with each other.

As shown in FIGS. 5, and 7 to 9, the communication part 43 is a cylindrical component extending in the upper-lower direction. In the communication part 43, the opening part at the upper end (an opening part) is disposed inside the first container 41, and the opening part at the lower end (another opening part) is disposed inside the second container 42, and the inside of the first container 41 is in communication with the inside of the second container 42. The communication part 43 is formed as a flow passage for the coffee liquid to flow through. The coffee liquid (filtered coffee liquid) extracted in the second container 42 flows out of the second container 42 into the first container 41 via the communication part 43. The communication part 43 is configured by using thermo-resistant glass. The communication part 43 is configured to be transparent or semi-transparent, and is configured so that the flowing coffee liquid is viewable from the outside. The communication part 43 is not limited to being formed by thermo-resistant glass, nor is it limited to being transparent or semi-transparent. The material, etc., forming the communication part 43 is selected in accordance with the specification or the purpose of the coffee maker 1. In addition, the shape of the communication part 43 is not limited to such configuration, but can be in a shape as appropriate in accordance with the specification or the purpose of the coffee maker 1. The communication part 43 is not limited to being formed by thermo-resistant glass, nor is it limited to being transparent or semi-transparent. The material, etc., forming the communication part 43 is selected in accordance with the specification or the purpose of the coffee maker 1.

As shown in FIGS. 5 and 7 to 9, with the coffee liquid permeating through the filter 44, the filter 44 filters out and removes the coffee powder mixed with the coffee liquid. The filter 44 is disposed on the filter stand 47 inside the second container 42, and divides the space inside the second container 42 into two (upper and lower) spaces. The filter 44 is disposed at a lower part inside the second container 42, and is in the vicinity above the opening part of the lower part of the communication part 43. In one (upper) of the spaces divided by the filter 44 inside the second container 42, no opening part of the communication part 43 is disposed, whereas the opening part of the communication part 43 is disposed inside the other (lower) space. The filter 44 is disposed inside the second container 42 by the user, and the coffee powder in a predetermined amount is disposed above the filter 44 by the user.

At the time of extracting the coffee liquid, in one (upper) of the spaces divided by the filter 44 inside the second container 42, the coffee powder is in a state of being mixed in the coffee liquid. At the time of extracting the coffee liquid, in the other (lower) space divided by the filter 44 inside the second container 42, the coffee liquid permeates through the filter 44, and the coffee powder is filtered out and removed from the coffee liquid by the filter 44.

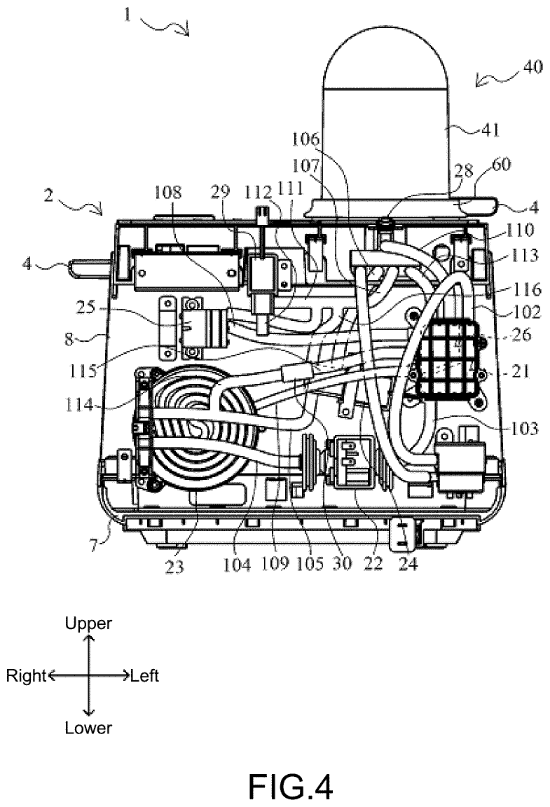

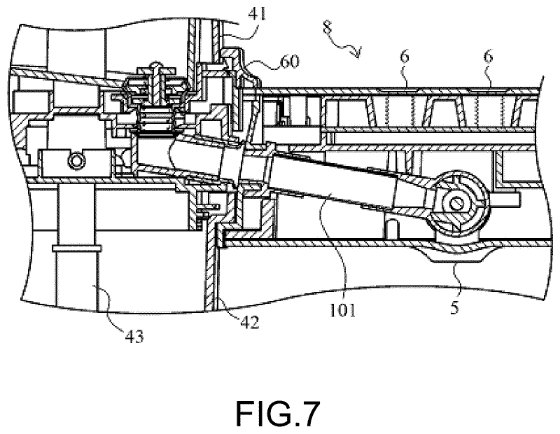

As shown in FIGS. 1 to 3, the support part 60 supports the first container 41 and the second container 42. The support part 60 is configured in a substantially flat disc shape. In a state in which the upper surface of the support part 60 is in contact with the lower end of the first container 41 (the opening of the first container 41), a packing is arranged to configure the support part 60 in a watertight manner. In the space configured by the upper surface of the support part 60 and the inside of the first container 41, water or coffee liquid, etc., is stored. The space configured by the upper surface of the support part 60 and the inside of the first container 41 is configured as an enclosed space. In a state in which the lower surface of the support part 60 is in contact with the upper end of the second container 42 (the opening of the second container 42), a packing is arranged to configure the support part 60 in a watertight manner. In the space configured by the lower surface of the support part 60 and the inside of the second container 42, the coffee liquid is extracted and filtered. At the substantially central part of the support part 60, a through hole penetrating in the upper-lower direction is formed. The communication part 43 is held by the support part 60 in a state of being inserted through the through hole. In a state in which the extraction unit 40 is installed to the main body 2, the support part 60 is disposed inside the upper part 9 of the main body 2, and is connected to flow pipes (a first flow pipe 101, a second flow pipe 102, a sixth flow pipe 106, a seventh flow pipe 107, and a thirteenth flow pipe 113) that are the flow passage of water, hot water, steam, or coffee liquid, etc., (see FIGS. 4 and 7).

### Detailed Configuration of Main Body

As shown in FIGS. 4 to 6, the main body 2 includes the control part 11, a power part 12, a subtank 21, a first pump 22, a heater 23, a first valve part 24, a second pump 25, a steam space 26, a drain 27, an atmospheric opening part 28, a second valve part 29, and a safety valve shaft 30, and the first control part 11, etc., is disposed inside the housing. In addition, the main body 2 includes multiple flow pipes 101 to 116 that are the flow passage of water, hot water, vapor, or coffee liquid, etc., and the flow pipes 101 to 116 are disposed inside the housing.

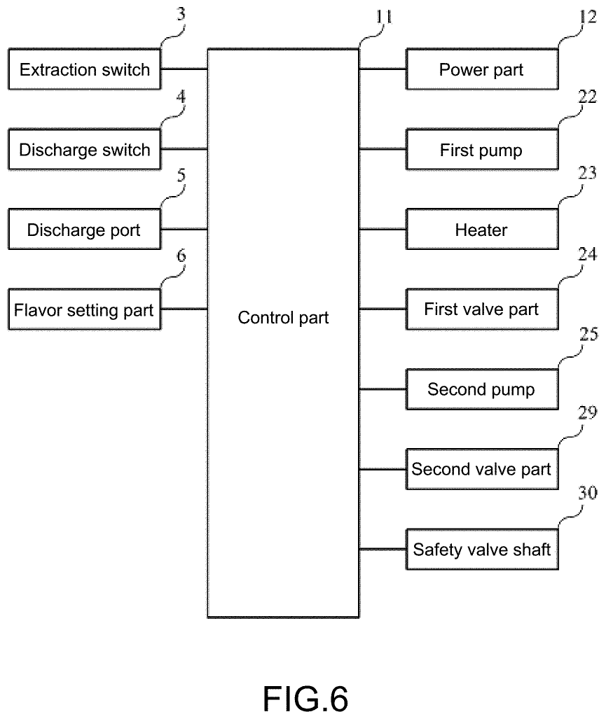

As shown in FIG. 6, the control part 11 controls various operations of the coffee maker 1 (the extraction switch 3, the discharge switch 4, the discharge port 5 (valve of the discharge port 5), the flavor setting part 6, the power part 12, the first pump 22, the heater 23, the first valve part 24, the second pump 25, the second valve part 29, and the safety valve shaft 30, etc.). The control part 11 is electrically connected to the extraction switch 3, the discharge switch 4, the discharge port 5 (valve of the discharge port 5), the power part 12, the first pump 22, the heater 23, the first valve part 24, the second pump 25, the second valve part 29, and the safety valve shaft 30, etc.

As shown in FIG. 6, the power part 12 supplies power to the control part 11, and supplies power for performing various operations with respect to the respective parts (the extraction switch 3, the discharge switch 4, the discharge port 5, the flavor setting part 6, the power part 12, the first pump 22, the heater 23, the first valve part 24, the second pump 25, the second valve part 29, and the safety valve shaft 30, etc.) of the coffee maker 1 from the control part 11. The power part 12 converts the power supplied from an outlet via an outlet cable (not shown) of the coffee maker 1 into a predetermined output power in accordance with each part of the coffee maker 1. In addition, the coffee maker 1 is configured to be able to store power.

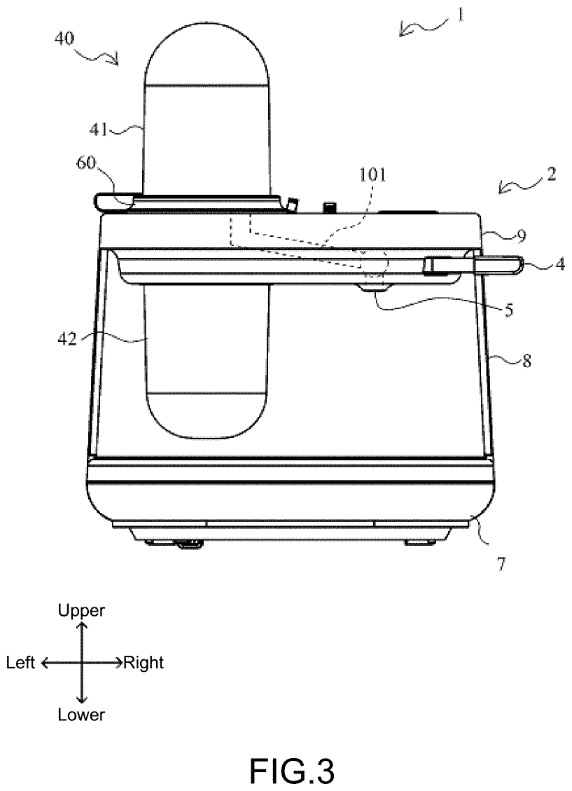

As shown in FIG. 3, 5, or 7, the extraction unit 40 (the second container 42) and the discharge port 5 are connected via the first flow pipe 101. When the user operates the discharge switch 4 to perform a discharge-ON operation, the valve of the discharge port 5 is opened, and the coffee liquid stored in the extraction unit 40 (first container 41) flows from the extraction unit 40 and is discharged from the discharge port 5 via the first flow pipe 101. When the user operates the discharge switch 4 to perform a discharge-OFF operation, the valve of the discharge port 5 is closed, and the discharge of the coffee liquid from the discharge port 5 is stopped. It may also be configured that, when the user operates the discharge switch 4, a predetermined amount of the coffee liquid is discharged from the discharge port 5, and discharge-OFF is set automatically.

As shown in FIG. 4 or 5, the extraction unit 40 (first container 41) and the subtank 21 are connected via the second flow pipe 102, the subtank 21 and the first pump 22 are connected via the third flow pipe 103, the first pump 22 and the heater 23 are connected via the fourth flow pipe 104, the heater 23 and the first valve part 24 are connected via the fifth flow pipe 105, and the first valve part 24 and the extraction unit 40 (second container 42) are connected via the sixth flow pipe 106.

As shown in FIG. 4 or 5, the subtank 21 is disposed on a flow passage of the water when the water stored in the first container 41 flows from the first container 41 into the second container 42. Not all of the water stored in the first container 41 is used as the hot water for soaking the coffee powder. A portion of the water stored in the first container 41 is temporarily stored in the subtank 21.

The first pump 22 sucks the water inside the first container 41 and supplies the water to the second container 42. With the user operating the extraction switch 3 to start an operation of extracting the coffee liquid, the first pump 22 performs an operation of sucking the water. The heater 23 is a water-boiling heater 23 (flow-through heater). The heater 23 can warm up (heat) the water to make hot water by making the water sucked by the first pump 22 and stored in the first container 41 pass through the heater 23, or warm up (heat) the water to generate steam by making the water sucked by the first pump 22 and temporarily stored in the subtank 21 pass through the heater 23. The first valve part 24 is a three-way valve. With the user operating the extraction switch 3 to start the operation of extracting the coffee liquid, the flow passage to the side of the sixth flow pipe 106 or the flow passage to the side of the sixteenth flow pipe 116 is in an open state.

As shown in FIG. 4 or 5, the extraction unit 40 (the first container 41) and the second pump 25 are connected via the seventh flow pipe 107, the second pump 25 and the steam space 26 are connected via the eighth flow pipe 108, the steam space 26 and the drain 27 are connected via the ninth flow pipe 109, and the steam space 26 and the atmospheric opening part 28 are connected via the tenth flow pipe 110.

The second pump 25 sucks gas inside the first container 41 to depressurize the inside of the first container 41. After the coffee liquid is extracted inside the second container 42, the inside of the first container 41 is depressurized to suck the coffee liquid inside the second container 42 to be supplied to the first container 41 via the communication part 43. After a predetermined time since the user operates the extraction switch 3 to start the operation of extracting the coffee liquid (after the extraction of the coffee liquid completes), the second pump 25 automatically performs the sucking operation. The steam space 26 is arranged on the flow passage of the steam, moisture, etc., when the steam, moisture, etc., inside the first container 41 flows out of the coffee maker 1. The drain 27 is a portion where the water collected in the steam space 26 flows through the ninth flow pipe 109 to be collected as unnecessary moisture, and is disposed inside the lower part 7 of the main body 2. The drain 27 is configured to be detachable and, for example, when a certain amount of waste water is collected, the user removes the drain 27 from the main body 2 to perform a process on the collected waste water. The atmospheric opening part 28 is a portion discharging unnecessary gas, steam, etc., out of the coffee maker 1 via the steam space 26, and is open at the upper end of the main body 2 (the upper part 9 of the main body 2).

As shown in FIGS. 4 or 5, the seventh flow pipe 107 (the seventh flow pipe 107 and the first container 41) and the second valve part 29 are connected via the eleventh flow pipe 111, and the second valve part 29 and the steam space 26 are connected via the twelfth flow pipe 112. The second container 42 and the subtank 21 are connected via the thirteenth flow pipe 113. The fifth flow pipe 105 and the safety valve shaft 30 are connected via the fourteenth flow pipe 114, and the safety valve shaft 30 and the subtank 21 are connected via the fifteenth flow pipe 115.

The second valve part 29 makes the inside of the first container 41 an enclosed space in a closed state. In the case where the internal pressure inside the first container 41 is to be lowered (to be atmospherically open), the second valve part 29 is set in an open state. In the case where a pressure inside the first container 41, the second container 42, and the flow pipes 101 to 116 is abnormally high, the safety valve shaft 30 is automatically set to the open state to lower the internal pressure inside the first container 41, the second container 42, and the flow pipes 101 to 116. The pressure inside the first container 41, the second container 42, and the flow pipes 101 to 116 is detected by a pressure sensor (not shown), and when detecting an abnormal value, the pressure sensor notifies the control part 11 that an abnormal value is detected.

As shown in FIG. 4 or 5, the first valve part 24 and the seventh flow pipe 107 are in communication via the sixteenth flow pipe 116. Since an end of the seventh flow pipe 107 is in communication with a steam flow part 46, it is configured that the steam from the heater 23 can flow into the first container 41 via the fifth flow pipe 105, the first valve part 24, the sixteenth flow pipe 116, the seventh flow pipe 107, and a steam flow part 46. The first valve part 24 is configured to be able to switch between flow passages of hot water, steam, etc., between the sixth flow pipe 106 and the sixteenth flow pipe 116. In the case where the hot water from the heater 23 flows into the second container 42 (pouring hot water into the second container 42), the first valve part 24 is set so that hot water flows to the sixth flow pipe 106. In the case where the steam from the heater 23 flows into the first container 41 at the time when the hot water and the coffee powder are stirred, the first valve part 24 is set so that steam flows in the sixteenth flow pipe 116.

### Regarding Operation of Extracting Coffee Liquid

In the following, an operation of extracting the coffee liquid by using the coffee maker 1 is described. Firstly, as shown in (A) of FIG. 10, when the user operates the extraction switch 3 to start the operation of extracting the coffee liquid, the first pump 22 operates, and the water stored in the first container 41 flows from the extraction unit 40 to pass through the second flow pipe 102 and flow into the subtank 21. Then, the water flowing into the subtank 21 flows out from the subtank 21, passes through the third flow tube 103, and flows into the heater 23 via the first pump 22 and the fourth flow pipe 104. The water flowing into the heater 23 is warmed up by the heater 23 and becomes hot water. In addition, the hot water warmed up by the heater 23 flows out from the heater 23, passes through the fifth flow pipe 105, and flows into the second container 42 via the first valve part 24 and the sixth flow pipe 106. When a predetermined amount of water flows into the second container 42, the operation of the first pump 22 stops. Accordingly, the water in the first container 41 flows out and becomes hot water, and the hot water flows into the second container 42 (the hot water is poured into the second container 42). In the operation of pouring hot water into the second container 42, the second valve part 29 is set in the open state.

Then, as shown in (B) of FIG. 10, the hot water and the coffee powder are mixed to soak the coffee powder in the hot water (in an immersed state) for a predetermined time inside the second container 42 (in the space of the upper part inside the second container 42). At this time, the first container 41 is in an empty state where no water is stored in the first container 41. The predetermined time during which the coffee powder is soaked in the hot water is set in advance. At this time as well, the second valve part 29 is also in the open state.

In addition, when the hot water and the coffee powder are mixed to soak the coffee powder in the hot water, steam flows into the second container 42, and the hot water and the coffee powder are stirred by the steam.

At this time, the first pump 22 operates to make the water temporarily stored in the subtank 21 flow from the subtank 21 into the heater 23, and the water is warmed up by the heater 23 to become steam. Then, the steam warmed up by the heater 23 flows from the heater 23 into the first container 41, and flows into the second container 42 via the communication part 43. By doing so, the steam flows into the second container 42, and the hot water and the coffee powder are stirred by the steam. When the hot water and the coffee powder are stirred by the steam for a predetermined time, the operation of the first pump 22 stops. The timing at which the steam flows into the second container 42 (the timing at which the first pump 22 operates), the amount of the steam, etc., are determined in advance in the program, etc. Regarding “when the hot water and the coffee powder are mixed to soak the coffee powder in the hot water, steam flows into the second container 42, and the hot water and the coffee powder are stirred by the steam”, it may also be configured to not perform the operation, or it may also be configured that the steam warmed up by the heater 23 flows into the second container 42 from the heater 23 without flowing via the first container 41 and the communication part 43.

After the coffee powder is soaked in the hot water for the predetermined time, as shown in (C) of FIG. 10, the coffee liquid permeates through the filter 44 to filter out the coffee powder from the coffee liquid by using the filter 44, whereas the extracted coffee liquid in the second container 42 flows from the second container 42 into the first container 41 via the communication part 43. At this time, a pressure difference between the inside of the first container 41 and the inside of the second container 42 is generated, and the coffee liquid is filtered by the filter 44 while being moved from the second container 42 to the first container 41 via the communication part 43. When the extracted coffee liquid is moved from the second container 42 to the first container 41, the second valve part 29 is set in the closed state, and the inside of the first container 41 is set in the enclosed state. As described above, the operation of extracting the coffee liquid is performed by the coffee maker 1.

As described above, the first container 41 (server container) stores water in the preceding stage of storing the coffee liquid and is configured to serve as a water tank as well as a server container. Therefore, compared with a container which does not serve as the water tank as well as the server container (the extraction container, the server container, and the water tank are separately configured), the number of parts can be reduced. Therefore, the coffee maker 1 can be compact, and the maintainability can be facilitated.

In addition, as described above, the first container 41 serves as the water tank as well as the server container, and the water stored in the first container 41 passes through the second flow pipe 102, the subtank 21, the third flow pipe 103, the first pump 22, the fourth flow pipe 104, the heater 23, the fifth flow pipe 104, the first valve 24, and the sixth flow pipe 106 and flows into the second container 42 as hot water. In addition, the extracted coffee liquid in the second container 42 generates a pressure difference between the inside of the first container 41 and the inside of the second container 42 to be filtered by the filter 44, while being moved from the second container 42 to the first container 41 via the communication part 43. Moreover, the first container 41, the second container 42, and the communication part 43 are configured so that the water, the coffee liquid, etc., inside the first container 41, the second container 42, and the communication part 43 is viewable from the outside. Therefore, the operation of extracting the coffee liquid can be expressively carried out.

As shown in FIGS. 1 to 3, the second container 42 is disposed below the first container 41. The lower end of the second container 42 is located lower than the lower end of the first container 41. Therefore, according to the coffee maker 1, the operation of extracting the coffee liquid can be expressively carried out.

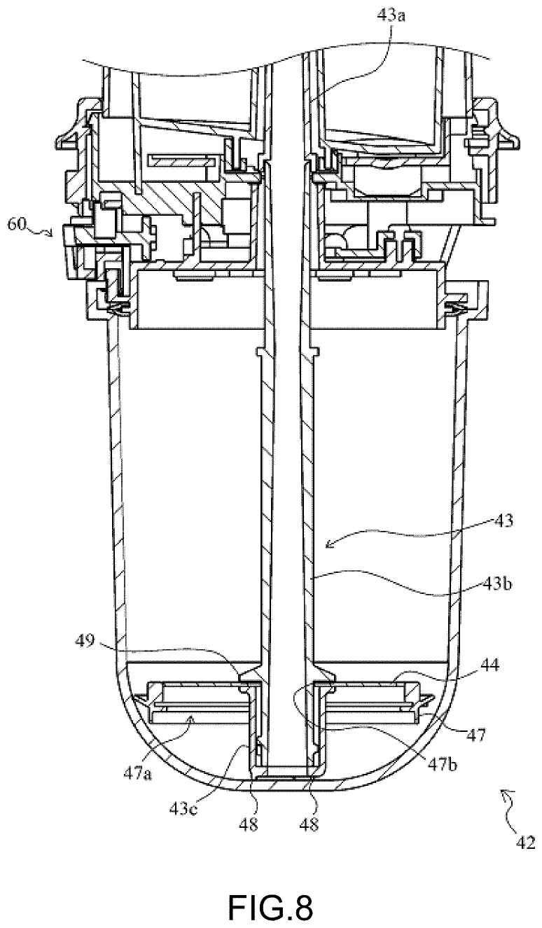

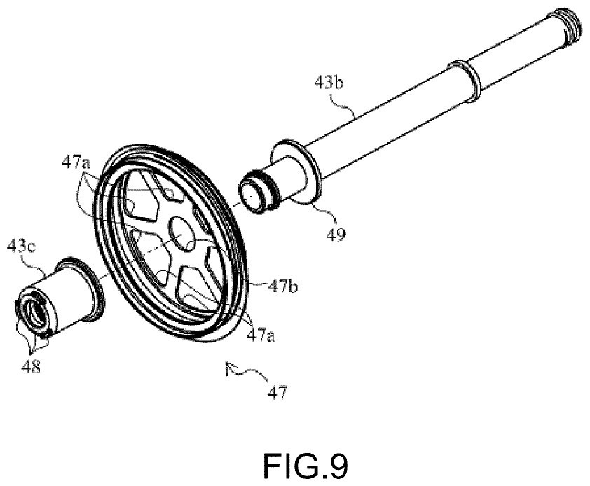

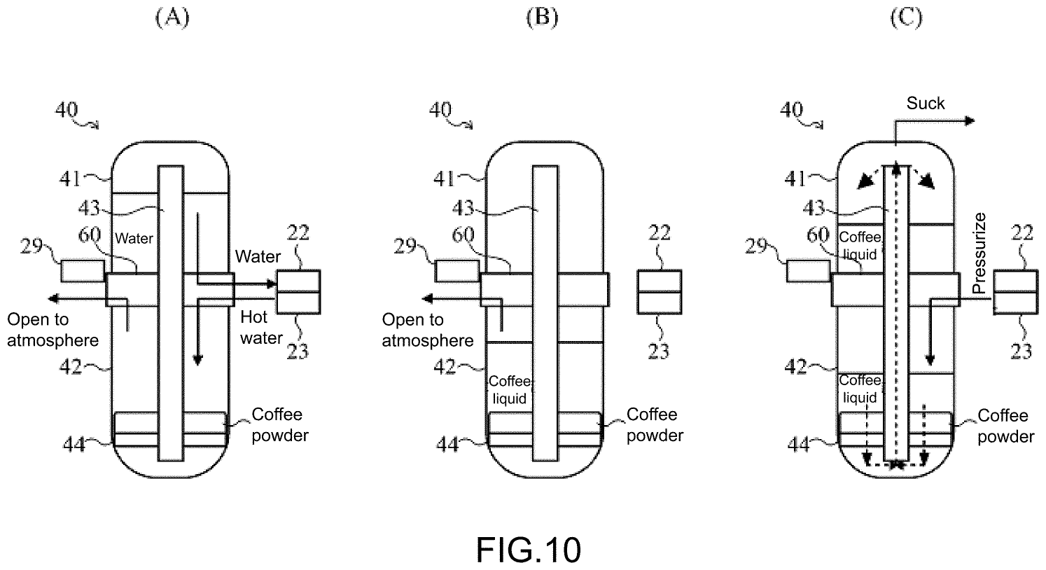

As shown in FIGS. 8 to 9, the communication part 43 includes multiple (e.g., three) contact parts 48. The contact parts 48 contact the inner surface at the lowermost position of the lower part (the inner surface of the bottom part) of the second container 42 inside the second container 42. The three contact parts 48 are respectively and evenly disposed in the circumferential direction of the opening part (another opening part) at the lower end of the communication part 43. The contact parts 48 protrude downward from the opening part at the lower end of the communication part 43 (the lower part side of the second container 42), and the protrusion side ends (lower ends) thereof are in contact with the lower part of the second container 42. The contact parts 48 protrude from the opening part at the lower end of the communication part 43 by about several mms (e.g., about 2 mm). In the state in which the contact parts 48 contact the second container 42, some gaps are formed between the opening part at the lower end of the communication part 43 and the inner surface of the lower part of the second container 42. The extracted coffee liquid (filtered coffee liquid) in the second container 42 passes through the gaps and flows into the communication part 43 from the opening part at the lower end of the communication part 43, and moves to the first container 41 via the communication part 43.

With such contact parts 48, at the time when the amount of the coffee liquid in the second container 42 is reduced when the coffee liquid moves to the first container 41 via the communication part 43, the extracted coffee liquid in the second container 42 passes through the gaps between the opening part at the lower end of the communication part 43 and the inner surface of the lower part of the second container 42 to flow into the communication part 43, so as to be transmitted through the contact parts 48. Therefore, it can prevent a small amount of the extracted coffee liquid in the second container 42 from remaining in the second container 42 without being moved to the first container 41 via the communication part 43. It is noted that the number of the contact parts 48 is not limited to be plural, but may also be singular. The number of the contact parts 48 may be two or less or four or more. The length of the protrusion of the contact part 48 is not limited to the above, but can be set as appropriate in accordance with the specification or the purpose of the coffee maker 1.

As shown in FIGS. 8 to 9, the filter stand 47 is formed in a substantially disc shape. The filter stand 47 is disposed in the second container 42 in a state in which the radially outer side end of the filter stand 47 contacts the inner surface of the cylindrical part of the second container 42. The filter 44 is disposed on the filter stand 47. In addition, the filter stand 47 has multiple opening parts 47a so that the coffee liquid filtered by the filter 44 can flow downward. The filter stand 47 has an insertion hole 47b at the central part of the filter stand 47, and the communication part 43 is kept in a state of being inserted into the insertion hole 47b.

As shown in FIGS. 8 to 9, the communication part 43 includes a first communication part 43a, a second communication part 43b, and a cap 43c. The first communication part 43a is a cylindrical component extending in the upper-lower direction.

The lower end of the first communication part 43a is inserted into the through hole of the support part 60 to be supported by the support part 60, and is disposed in the first container 41. A thread groove is formed on the inner peripheral surface of the lower end of the first communication part 43a. The second communication part 43b is a cylindrical component extending in the upper-lower direction. The upper end of the second communication part 43b is inserted into the through hole of the support part 60 to be supported by the support part 60, and is disposed in the second container 42. By screwing the lower end of the first communication part 43a and the upper end of the second communication part 43b, the first communication part 43a and the second communication part 43b are connected.

By releasing the state in which the second communication part 43b is screwed to the first communication part 43a to be pulled out from the support part 60, thereby removing the second communication part 43b from the first communication part 43a and the support part 60, the second communication part 43b (communication part 43) can be removed from the second container 42. That is, the second communication part 43b (communication part 43) is configured to be detachable with respect to the support part 60. Therefore, at the time of maintenance, such as cleaning, the communication part 43 can be removed from the second container 42, and the maintainability can be facilitated.

A flange 49 is provided at the lower part (lower side of an upper-lower intermediate part) of the second communication part 43b. The flange 49 makes contact when the communication part 43 is inserted into the insertion hole 47b of the filter stand 47, and is configured to position the filter stand 47 with respect to the communication part 43. A thread ridge is formed on the outer peripheral surface of the lower end of the second communication part 43b. The cap 43c is a cylindrical component, and a thread groove is formed on the inner peripheral surface of the cap 43c. The cap 43c is installed by being screwed to the lower end of the second communication part 43b. By installing the cap 43c to the second communication part 43b in the state in which the communication part 43 is inserted into the insertion hole 47b of the filter stand 47, the communication part 43 and the filter stand 47 are integrally configured.

Accordingly, since the second communication part 43b (communication part 43) and the filter stand 47 are integrally configured, when the second communication part 43b (communication part 43) is removed from the second container 42 at the time of maintenance, such as cleaning, the filter stand 47 can be removed, together with the communication part 43, from the second container 42, and the maintainability can be facilitated. In addition, by releasing the state in which the cap 43c is screwed to the second communication part 43b, the filter stand 47 can be removed from the communication part 43. That is, the filter stand 47 is configured to be detachable with respect to the communication part 43. Therefore, at the time of maintenance, such as cleaning, the filter stand 47 can be removed from the communication part 43, and the maintainability can be facilitated.

As the configuration “a pressure difference between the inside of the first container 41 and the inside of the second container 42 is generated, and the coffee liquid is filtered by the filter 44 while being moved from the second container 42 to the first container 41 via the communication part 43”, for example, it may also be that the inside of the first container 41 is sucked (e.g., the gas inside the first container 41 is sucked) to depressurize the inside of the first container 41, and the extracted coffee liquid in the second container 42 flows from the second container 42 into the first container 41 via the communication part 43. At this time, the second pump 25 is operated to suck the inside of the first container 41 via the seventh flow pipe 107. Accordingly, the inside of the first container 41 is depressurized through the sucking of the second pump 25, and the extraction of the coffee liquid inside the second container 42 and the movement of the coffee liquid from the second container 42 to the first container 41 can be performed. That is, the negative pressure inside the second container 42 is configured to extract and move the coffee liquid.

According to above, not all of the water stored in the first container 41 serves as the hot water for soaking the coffee powder. The subtank 21 temporarily stores a portion of the water stored in the first container 41. Therefore, as the configuration “a pressure difference between the inside of the first container 41 and the inside of the second container 42 is generated, and the coffee liquid is filtered by the filter 44, while being moved from the second container 42 to the first container 41 via the communication part 43”, for example, in the case where steam flows into the second container 42 to pressurize the inside the second container, and the extracted coffee liquid in the second container 42 is moved from the second container 42 to the first container 41 via the communication part 43, the water for making the steam flowing into the second container 42 can be temporarily stored in the subtank 21. Therefore, the situation in which the extraction of the coffee liquid cannot be not appropriately performed because the water (hot water, steam, etc.) other than the water (hot water) for soaking the coffee powder cannot be secured can be avoided.

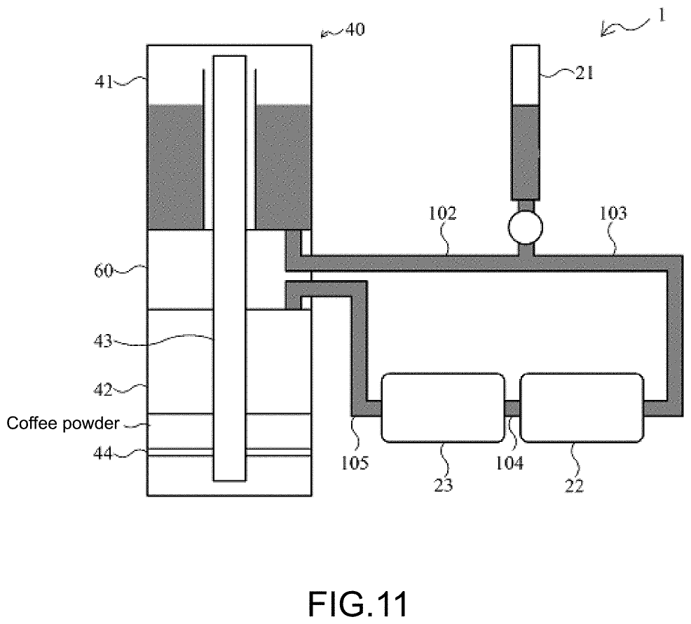

As shown in FIG. 11, the subtank 21 can be disposed to overlap with the first container 41 when viewed in a side view. At this time, it is configured that the water level of the water stored in the subtank 21 can be recognized from the outside. In addition, when water is stored in the first container 41 or when the first container 41 (the extraction unit 40) in which water is stored is installed to the main body 2, the water stored in the first container 41 is configured to flow into the subtank 21 via the second flow pipe 102. Therefore, it can be recognized from the outside that the water level of the water stored in the first container 41 and the water level of the water stored in the subtank 21 are the same. Therefore, the amounts of the water stored in the first container 41 and the subtank 21 can be modulated easily, and an amount of water corresponding to the number of cups of the extracted coffee liquid can be stored in the first container 41 and the subtank 21.

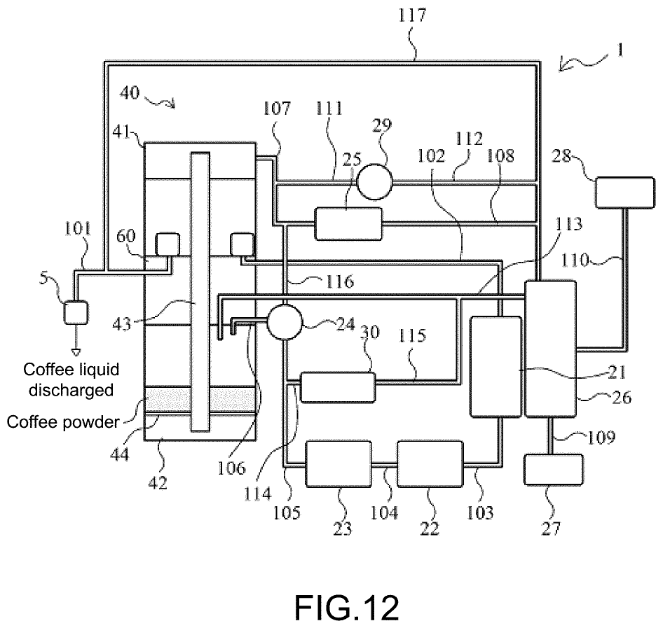

As shown in FIG. 12, the main body 2 may also include a seventeenth flow pipe 117. The seventeenth flow pipe 117 is connected with the first flow pipe 101 and the eighth flow pipe 108 or the twelfth flow pipe 112. Via the seventeenth flow pipe 117, the coffee liquid discharge path (the first flow pipe 101) from the first container 41 to the discharge port 5 is in communication with the path of introducing external gas (the eighth flow pipe 108 in communication with the second pump 25 or the twelfth flow pipe 112 in communication with the eighth flow pipe 108)). Therefore, after the discharge of the coffee liquid from the discharge port 5 completes, by operating the second pump 25 (e.g., operating for about one second), the external gas flows in the first flow pipe 101, thereby being able to discharge the coffee liquid remaining in the coffee liquid discharge path (the first flow pipe 101) from the discharge port 5. Therefore, after the discharge of the coffee liquid completes, the coffee liquid remaining in the coffee liquid discharge path (first flow pipe 101) can be prevented from dripping down (dropping) from the discharge port 5.

The control part 11 is configured to discharge the remaining coffee liquid in the coffee liquid discharge path (the first flow pipe 101) from the discharge port 5 by automatically operating the second pump 25 after the operation of discharging the coffee liquid from the discharge port 5 completes. At this time, when the user operates the discharge switch 4 to perform the discharge-OFF operation (when the valve of the discharge port 5 is closed), the control part 11 is configured to detect the discharge-OFF of the discharge switch 4 and automatically operate the second pump 25. In addition, in the case of the configuration where the state automatically becomes discharge-OFF after a predetermined amount of the coffee liquid is discharged from the discharge port 5 when the user operates the discharge switch 4, the control part 11 is configured to detect the discharge-OFF of the discharge switch 4 and automatically operate the second pump 25. In addition, it can also be configured that, with the user operating a predetermined operation tool (e.g., an operation switch provided in the main body 2, a remote controller, etc.), that is, with the user having control, the coffee liquid remaining in the coffee liquid discharge path (the first flow pipe 101) is discharged from the discharge port 5.

Here, a control substrate (not shown) is provided below the extraction switch 3 or the flavor setting part 6, and the control substrate is disposed above the first flow pipe 101 (the vicinity of the first flow pipe 101). Since the first flow pipe 101 and the path of introducing external gas (the eighth flow pipe 108 in communication with the second pump 25 or the twelfth flow pipe 112 in communication with the eighth flow pipe 108) are in communication with each other via the seventeenth flow pipe 117, the second valve part 29 is in the open state when being open to the atmosphere, and the atmosphere flows into the first flow pipe 101 and flows out from the discharge port 5. Accordingly, the control substrate disposed in the vicinity of the first flow pipe 101 can be cooled off by the atmosphere flowing through the first flow pipe 101.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A coffee maker, comprising:
an extraction container extracting coffee liquid from hot water and coffee powder;
a server container storing the coffee liquid;
a communication part communicating an inside of the extraction container and an inside of the server container; and
a filter, disposed inside the extraction container, wherein the coffee powder is filtered out and removed by permeating the coffee liquid through the filter,
wherein the coffee maker is configured to filter the coffee liquid by using the filter while moving the coffee liquid from the extraction container to the server container via the communication part, and
the server container stores water as basis of the hot water for extracting the coffee liquid.

2. The coffee maker as claimed in claim 1, wherein the extraction container is disposed below the server container.

3. The coffee maker as claimed in claim 1, wherein the communication part comprises a contact part, and
the contact part protrudes toward a side of a lower part of the extraction container from an opening part at a lower end of the communication part, and contacts an inner surface of the lower part of the extraction container inside the extraction container.

4. The coffee maker as claimed in claim 1, comprising a subtank which temporarily stores a portion of the water stored in the server container.

5. The coffee maker as claimed in claim 1, wherein, after discharge of the coffee liquid completes, external gas flows along a discharge path of the coffee liquid from the server container to a discharge port to discharge the coffee liquid remaining in the discharge path of the coffee liquid.

6. The coffee maker as claimed in claim 1, wherein the coffee maker is configured to generate a pressure difference between the inside of the extraction container and the inside of the server container and filter the coffee liquid by using the filter while moving the coffee liquid from the extraction container to the server container.

7. The coffee maker as claimed in claim 2, wherein the communication part comprises a contact part, and
the contact part protrudes toward a side of a lower part of the extraction container from an opening part at a lower end of the communication part, and contacts an inner surface of the lower part of the extraction container inside the extraction container.

8. The coffee maker as claimed in claim 2, comprising a subtank which temporarily stores a portion of the water stored in the server container.

9. The coffee maker as claimed in claim 3, comprising a subtank which temporarily stores a portion of the water stored in the server container.

10. The coffee maker as claimed in claim 2, wherein, after discharge of the coffee liquid completes, external gas flows along a discharge path of the coffee liquid from the server container to a discharge port to discharge the coffee liquid remaining in the discharge path of the coffee liquid.

11. The coffee maker as claimed in claim 3, wherein, after discharge of the coffee liquid completes, external gas flows along a discharge path of the coffee liquid from the server container to a discharge port to discharge the coffee liquid remaining in the discharge path of the coffee liquid.

12. The coffee maker as claimed in claim 4, wherein, after discharge of the coffee liquid completes, external gas flows along a discharge path of the coffee liquid from the server container to a discharge port to discharge the coffee liquid remaining in the discharge path of the coffee liquid.

13. The coffee maker as claimed in claim 2, wherein the coffee maker is configured to generate a pressure difference between the inside of the extraction container and the inside of the server container and filter the coffee liquid by using the filter while moving the coffee liquid from the extraction container to the server container.

14. The coffee maker as claimed in claim 3, wherein the coffee maker is configured to generate a pressure difference between the inside of the extraction container and the inside of the server container and filter the coffee liquid by using the filter while moving the coffee liquid from the extraction container to the server container.

15. The coffee maker as claimed in claim 4, wherein the coffee maker is configured to generate a pressure difference between the inside of the extraction container and the inside of the server container and filter the coffee liquid by using the filter while moving the coffee liquid from the extraction container to the server container.

16. The coffee maker as claimed in claim 5, wherein the coffee maker is configured to generate a pressure difference between the inside of the extraction container and the inside of the server container and filter the coffee liquid by using the filter while moving the coffee liquid from the extraction container to the server container.
